(19) United States
(12) Patent Application Publication
(10) Pub. No.: US 2011/0083314 A1
(43) Pub. Date: Apr. 14, 2011

(54) METHOD AND APPARATUS FOR REPLACING COKE OVEN WALL

(75) Inventor: Billy Carr Baird, Sturgis, KY (US)

(73) Assignee: Saturn Machine & Welding Co., Inc., Sturgis, KY (US)

(21) Appl. No.: 12/949,310

(22) Filed: Nov. 18, 2010

Related U.S. Application Data
(62) Division of application No. 11/681,228, filed on Mar. 2, 2007.

(51) Int. Cl. B23P 6/00; B23P 19/00

(52) U.S. Cl. 29/402.08; 29/700

(57) ABSTRACT

Methods of replacing a damaged wall of a coke oven having a height h and a length l are provided. In one aspect, the method comprises removing the damaged wall from the coke oven, casting, outside of the oven, a replacement wall section having a length equal to the length l of the damaged coke oven wall and a height equal to the height h of the damaged coke oven wall, and positioning, inside the coke oven, the replacement wall section.

### RELATED APPLICATIONS

This application is a divisional of application Ser. No. 11/681,228 filed Mar. 2, 2007 which is hereby incorporated by reference herein.

### FIELD

This relates generally to coke ovens, and more particularly to the walls of coke ovens and to methods of replacing those walls.

### BACKGROUND

Coke oven batteries include a number of horizontal coke ovens that range up to twenty feet or more in height and up to fifty feet in length. An oven is approximately eighteen inches wide. Individual ovens are laterally arranged in groups to form a battery. A coke oven has a chamber with opposite open ends closed by doors. Positioned on both sides of a coke oven chamber are heating walls.

Internally of the heating walls are vertical heating flues in which combustion of air and gas takes place. The combustion produces heat which moves vertically through the flues. Heat is then supplied to the coking chambers from the adjacent heating flues through the heating walls.

The heating walls are heated to an elevated temperature to carry out the coking process. The coke oven doors at both the pusher side and the coke side are closed when coal is being coked within the coke oven chambers. These doors are removed when the coke is pushed out of the ovens. Thermal expansion and contraction of the bricks, and normal wear due to pushing the coke out of the coking chamber, results in spalling, deterioration, and eventually disintegration of entire brick sections of the heating walls.

One method of replacing the heating walls entails replacing one-by-one the old refractory brick with new refractory brick. The new bricks are laid in courses to form the new, replacement wall. Such a process is laborious, expensive, and time consuming, especially when an entire wall requires not just repair but wholesale replacement.

It is desirable to provide a method of replacing coke oven walls which is not nearly so laborious, expensive, and time consuming.

### SUMMARY

Accordingly, methods of replacing a damaged wall of a coke oven having a height h and a length/are provided. In one aspect, the method comprises removing the damaged wall from the coke oven, casting, outside of the oven, a replacement wall section having a length equal to the length l of the damaged coke oven wall and a height equal to the height h of the damaged coke oven wall, and positioning, inside the coke oven, the replacement wall section.

In another aspect, the method comprises removing the damaged wall from the coke oven, casting, outside of the oven, a plurality of replacement wall sections, each replacement wall section having a length equal to the length l of the damaged coke oven wall and a height equal to a fraction of the height h of the damaged coke oven wall, and positioning, inside the coke oven, the plurality of replacement wall sections one on top of another, such that the plurality of replacement wall sections has a combined height equal to the height h of the damaged coke oven wall.

The plurality of replacement wall sections can comprise a lower half section and an upper half section.

In yet another aspect, the method comprises removing the damaged wall from the coke oven, casting, outside of the oven, a plurality of replacement wall sections, each replacement wall section having a length equal to a fraction of the length l of the damaged coke oven wall and a height equal to the height h of the damaged coke oven wall, and positioning, inside the coke oven, the plurality of replacement wall sections end to end, such that the plurality of replacement wall sections has a combined length equal to the length l of the damaged coke oven wall.

The plurality of replacement wall sections can comprise a pusher side section, a middle section, and a coke side section. Abutting ones of the pusher side, middle, and coke side sections can be formed to have mating, interlocking ends. The replacement wall sections can be cast with air/gas passages and vertical flues therein.

In still another aspect, a method of replacing a damaged wall of a coke oven comprises removing the damaged wall from the coke oven, casting, outside of the oven, a replacement wall section, providing first and second fixture plates, sandwiching the replacement wall section between the plates, lifting the replacement wall section by lifting the plates, positioning the plates and hence the replacement wall section inside the coke oven, and removing the plates from the replacement wall section.

The method can further comprise providing a layer of rubber on each of the fixture plates for contacting the replacement wall section so as to avoid damage to the wall section during installation of the wall section in the oven. The method can further comprise providing rolling trucks secured to the fixture plates for rolling movement of the replacement wall section and plates in the oven during installation of the wall section in the oven. The method can further comprise interconnecting the rolling trucks and the fixture plates with hydraulic cylinders to facilitate leveling and load distribution of the fixture plates and hence replacement wall section during installation of the replacement wall section in the oven. The method can further comprise providing a computer and a controller in operable association with the hydraulic cylinders to automate leveling and load distribution of the fixture plates and hence replacement wall section during installation of the replacement wall section in the oven. The method can further comprise casting holes through the replacement wall section, and compressing the replacement wall section between the fixture plates by compression pins which pass through the holes in the wall section and connect the fixture plates. The replacement wall section can be installed in the oven through an open end of the oven or through an open roof of the oven. The method can further comprise casting mortar joints in at least one of upper and lower surfaces of the replacement wall section. The method can further comprise providing a vertically movable leveling bed adjacent the coke oven, and at least partially supporting the replacement wall section and fixture plates with the leveling bed as the replacement wall section is installed in the oven. The method can further comprising providing a frame, and interconnecting the leveling bed and the frame with hydraulic cylinders to facilitate vertical movement of the leveling bed during installation of the replacement wall section in the oven. The method can further comprise providing a computer and a controller in operable association with the hydraulic cylinders to automate vertical movement of the leveling bed during installation of the replacement wall section in the oven.

In still a further aspect, a fixture for installing a replacement wall section into a coke oven comprises a pair of plates for sandwiching the replacement wall section therebetween, rolling trucks for rolling movement of the replacement wall section and the plates during installation of the wall section in the oven, hydraulic cylinders interconnecting the plates and trucks, and a computer/controller in operable association with the hydraulic cylinders to automate leveling and load distribution of the fixture plates and hence the wall section during installation of the wall section in the oven.

Each of the fixture plates can have a layer of rubber thereon for contacting the wall section so as to avoid damage to the wall section during installation of the wall section in the oven. Angle clips can be removably secured to bottoms of the plates to add support for the wall section during installation of the wall section in the oven. The upward facing surface of each of the angle clips can have a layer of rubber thereon for contacting a bottom of the wall section so as to avoid damage to the wall section during installation of the wall section in the oven. The fixture can further comprise a plurality of compression pin assemblies for securing the plates to the wall section. Each compression pin assembly can comprise a two-piece outer sleeve, and a two-piece inner pin. One portion of the two-piece inner pin can have a male threaded portion on one end which fits in a complimentary female threaded portion of the other portion of the two-piece inner pin. Bellville washers can be placed on the other end of the one portion of the two-piece inner pin, which can be threaded, and a nut can be placed on the other end of the one portion of the two-piece inner pin. The fixture plates can be side plates, and can further comprise a pair of end plates removably secured to ends of the side plates. The side plates and the end plates can each have a layer of rubber thereon for contacting the wall section so as to avoid damage to the wall section during installation of the wall section in the oven.

### DRAWINGS

FIG. 1 is a side view of apparatus for installing replacement oven wall sections,

FIG. 2A is an exploded cross-sectional view taken along line 2A-2A in FIG. 1,

FIG. 2B is an assembled view of the apparatus of FIG. 2A,

FIG. 3 is an enlarged partial cross-sectional view of a compression pin assembly used in the apparatus of FIGS. 1, 2A, and 2B,

FIGS. 4A-4C are successive steps in installing replacement oven wall sections,

FIG. 5 is an alternative method to the one shown in FIGS. 4A-4C for installing replacement oven wall sections,

FIG. 6 is a side view of an alternative embodiment of replacement oven wall sections, and

FIG. 7 is a side view of another alternative embodiment of replacement oven wall.

### DESCRIPTION

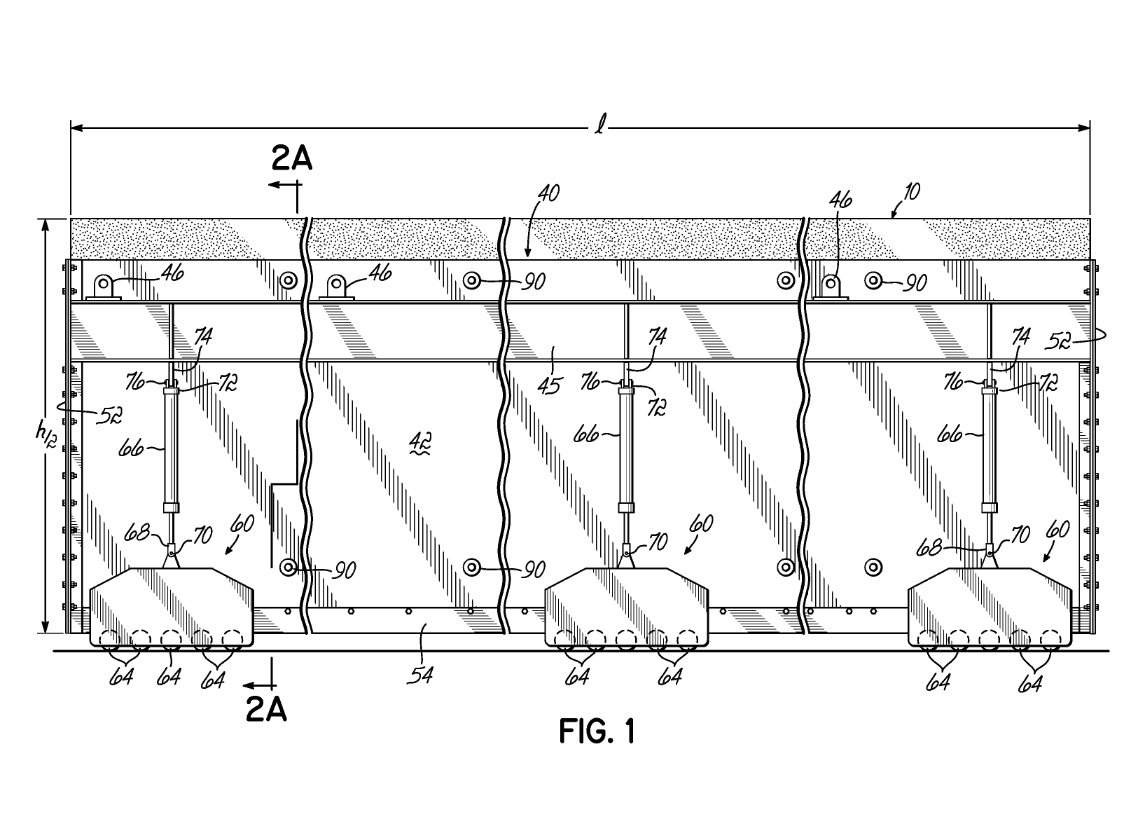

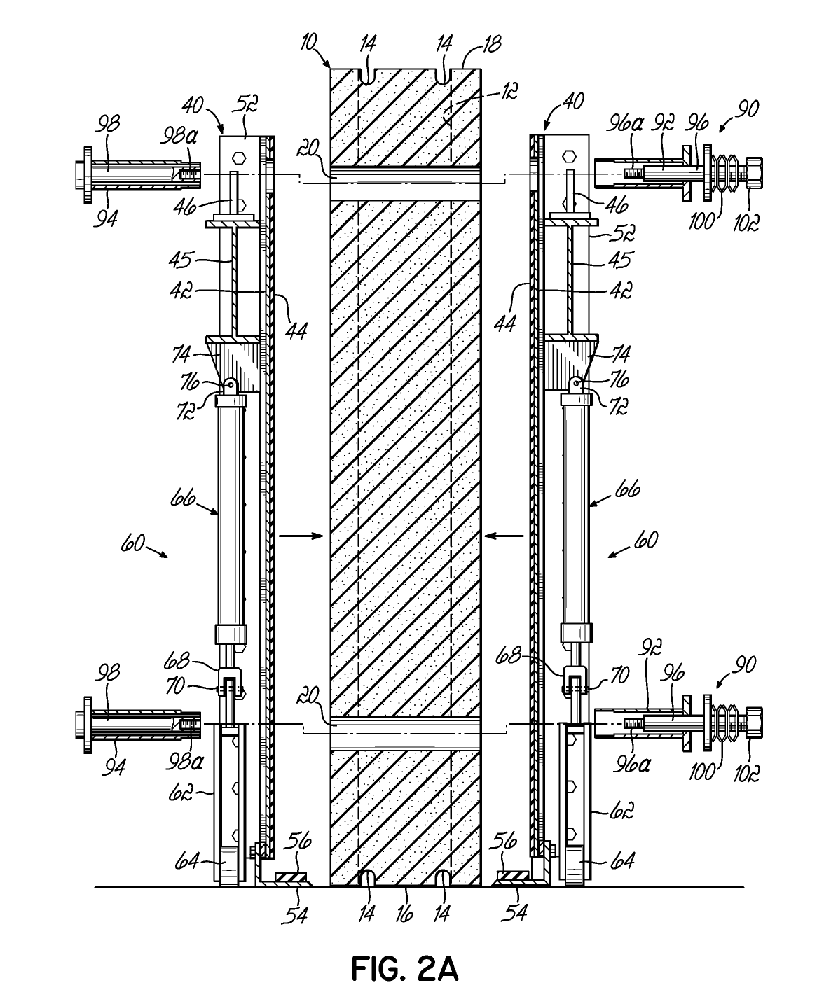

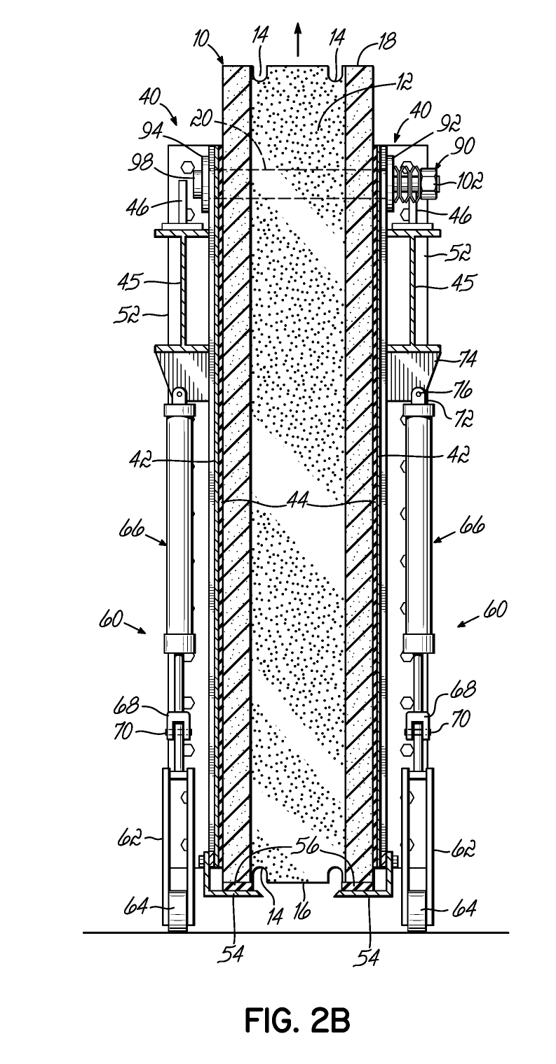

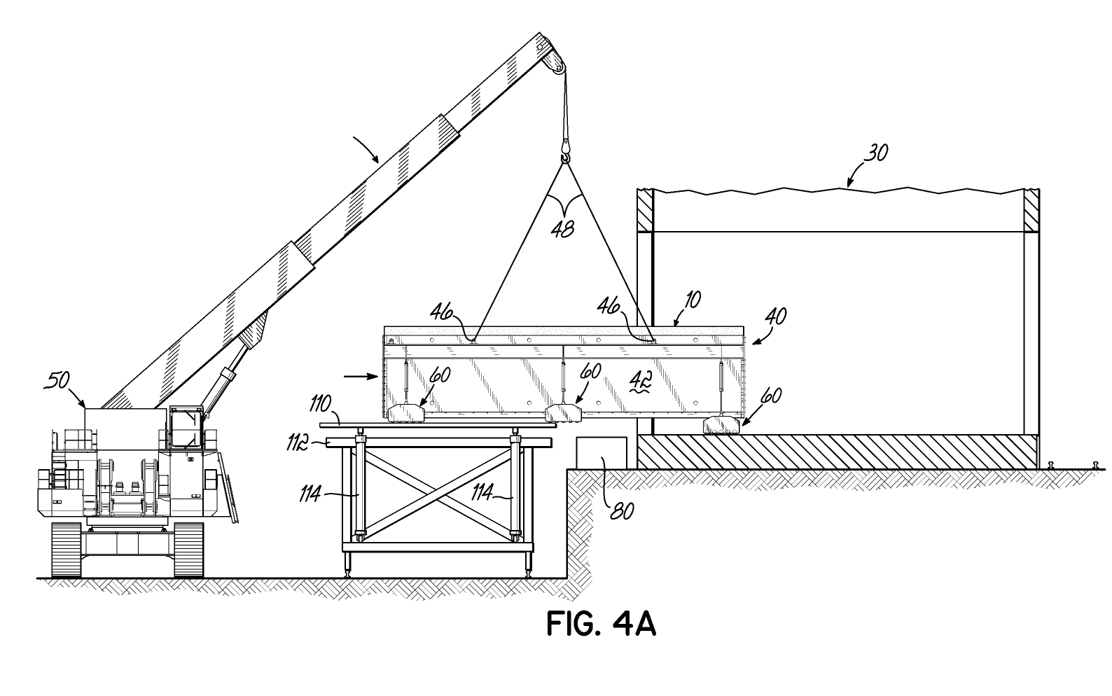

Referring first to FIGS. 1, 2A, and 2B, illustrated is a replacement coke oven wall section 10 and a fixture or an apparatus 40 for installing the replacement wall section 10 into a coke oven 30. The coke oven replacement wall section 10 is cast outside of the oven with, for example, a zero expansion pourable and castable refractory material or mix. A suitable pouring fixture or mold (not shown) can be used to cast the replacement wall section 10, and can include a pair of side plates, a pair of end plates removably bolted to the side plates, and a bottom plate removably bolted to the side plates. The pouring fixture plates can reinforced with suitable support beams as required. Forms (not shown) can be positioned in the pouring fixture or mold so as to form the replacement wall section 10 with air/gas passages and/or vertical flues 12 therein. The replacement wall section 10 can also be formed to include mortar joints 14 in lower wall surface 16, in upper wall surface 18, or in lower and upper wall surfaces 16, 18, depending on the height of the replacement wall section 10. The replacement wall section 10 can also be formed to include holes 20 for securing apparatus 40 to the wall section 10 for lifting and placement of the wall section 10. Once thusly formed, the replacement wall section 10 is then positioned inside the coke oven 30 (FIGS. 4A-C) and mortared/grouted as required.

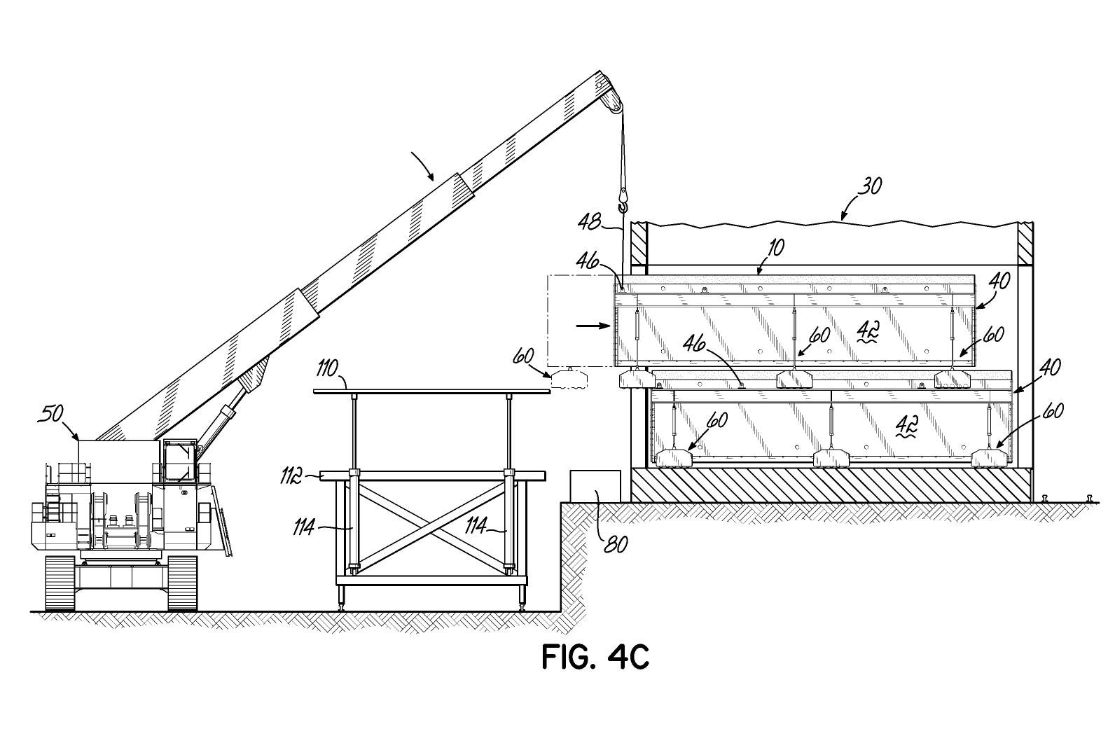

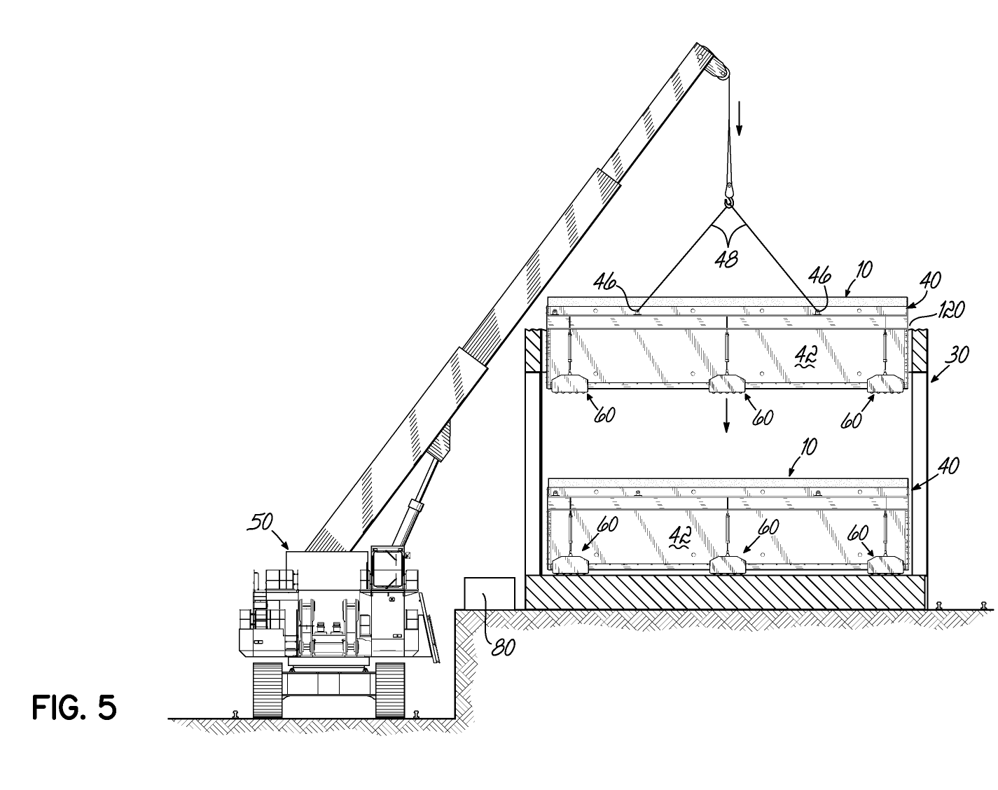

In the embodiment shown in FIGS. 1, 2A, 2B, 4A-C, and 5, the replacement wall section 10 has a length which is equal to the length l of the damaged coke oven wall to be replaced, and a height which is equal to a fraction of the height h of the damaged coke oven wall to be replaced, for example, one-half of the height h of the damaged coke oven wall. Alternatively, the replacement wall section 10 has a length which is equal to the length l of the damaged coke oven wall, and a height which is equal to the height h of the damaged coke oven wall, as shown in FIG. 7. Yet still alternatively, the replacement wall section 10 has a length which is equal to a fraction of the length l of the damaged coke oven wall, for example, roughly one-third of the length l of the damaged coke oven wall, and a height with is equal to the height h of the damaged coke oven wall, as shown in FIG. 6.

Referring back to FIGS. 1, 2A, and 2B, the apparatus 40 for lifting the replacement wall section 10 and placing it in the oven 30 can comprise a pair of steel side plates 42 each of which can have a layer of rubber 44 on the inward facing surface of the plate 42 for contacting the sides of the replacement wall section 10 so as to avoid damage to the wall section during lifting and installation into the oven 30. Each plate 42 can include one or more steel support beams 45, for example I-beams, secured thereto to provide the required stiffness and strength for supporting the replacement wall 10 during installation, and to provide a travel platform, as will be described in more detail below. Lifting lugs 46 can be removably secured to the beams 45 for lifting the apparatus 40 and wall section 10 by, for example, cables 48 raised and lowered by a crane 50 (FIGS. 4A-C) thus lifting the wall section 10 by lifting the plates 42. The lifting lugs 46 can be removed so as not to interfere with the beams 45 functioning as a travel platform, as will be described in more detail below. Removable end plates 52 can be bolted to the ends of the side fixture plates 42 for further stiffness and strength, each of which, like side plates 42, can have a layer of rubber 44 on the inward facing surface of the plate 52 for contacting the ends of the replacement wall section 10 so as to avoid damage to the wall section during lifting and installation into the oven 30. Each side plate 42 can have removable angle clips 54 bolted to the bottom thereof to add support for the wall section 10 during lifting and installation. The upward facing surface of each of the clips 54 can have a layer of rubber 56 thereon for contacting the bottom of the replacement wall section 10 so as to avoid damage to the wall section during lifting and installation into the oven 30. Once the wall section 10 is positioned correctly horizontally and before the wall section 10 is lowered to mate with the oven floor the angle clips 54 are removed to provide access to the bottom of the wall section 10 to grout it to the oven floor. Once in position the plates 42 are removed from the wall section.

Each side plate 42 can have self leveling transport truck assemblies 60 to assist during the installation of the wall section 10 into the oven chamber. The truck assemblies 60 can each comprise a wheel housing 62 housing a plurality of wheels 64. Hydraulic cylinders 66 can be interconnected between the rolling trucks 60 and their respective fixture side plate 42. For example, a hydraulic cylinder 66 can have its piston end 68 pivotally connected to the upper end of the truck wheel housing 62 at 70, and its cylinder end 72 pivotally connected to a support 74 at 76, which support 74 can be secured to beam 45 (or otherwise to side fixture plate 42). The axes of the pivot connections 70, 76 of the hydraulic cylinders 66 to the truck assemblies 60 and beams 44, respectively as illustrated can be perpendicular to one another to thereby help to distribute the load of the wall section 10 evenly. The hydraulic cylinders 66 can be computer controlled via a computer processor/controller 80 (FIGS. 4A-C) to ensure that uniform pressure is applied to the floor of the oven during installation of the replacement wall section 10. In the event that multiple wall sections are stacked one atop another as shown in FIGS. 4A-4C, the truck assemblies 60 of the uppermost wall section 10 and apparatus 40 can run on the support beams 45 of the lowermost wall section 10 and apparatus 40.

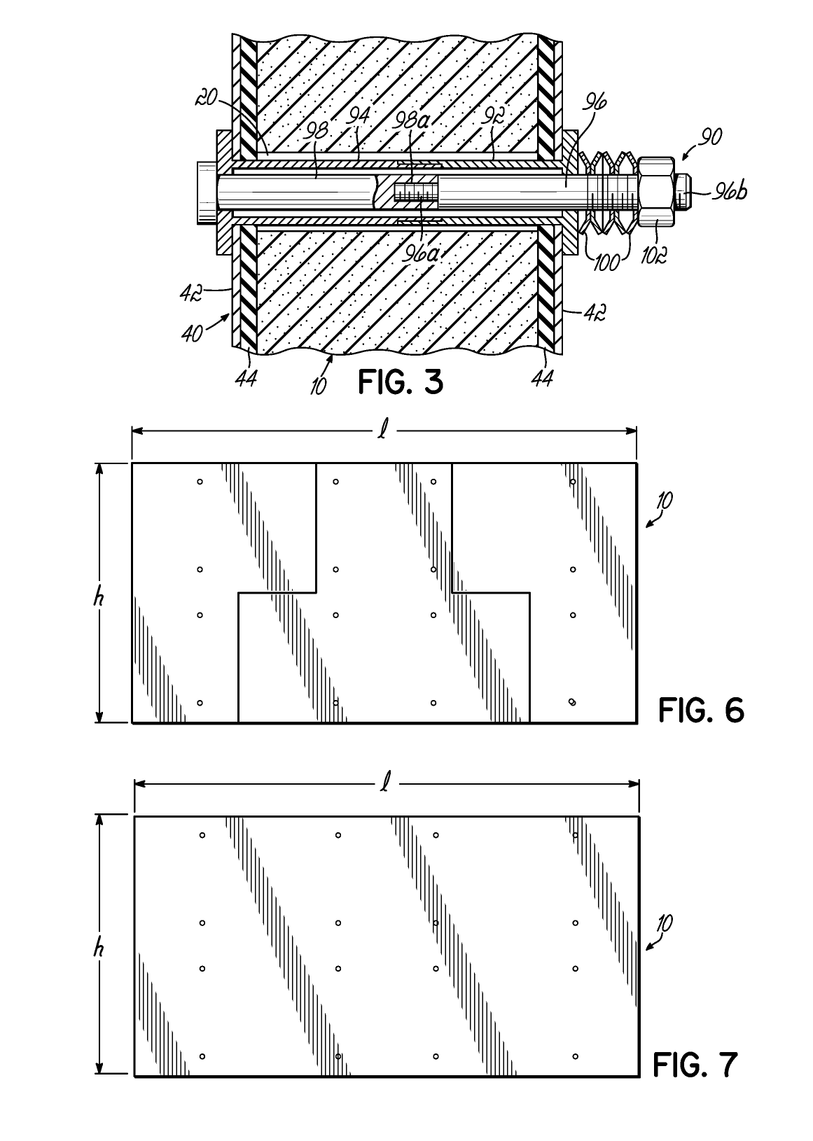

FIG. 3 illustrates a two piece compression pin assembly 90 which can be used to secure the two fixture plates 42 to the replacement wall section 10. The pins 90 pass through the holes 20 in the replacement wall section, which holes 20 can be purposely larger than the pin assembly 90 to make sure that the pin assembly 90 does not contact the wall section 10. Each pin assembly 90 can comprise a two-piece outer sleeve 92, 94 and a two-piece inner pin 96, 98. Pin portion 96 has male threaded portion 96a which fits in complimentary female threaded portion 98a of pin portion 98. Bellville washers 100 are placed over the opposite threaded end 96b of pin portion 96 to apply consistent pressure on each assembly and are tightened with nut 102 to apply pressure on the Bellville washers 100.

As shown in FIGS. 4A-4C, a leveling bed 110 can be used to aid installation of replacement wall section 10 into the coke oven 30. Leveling bed 110 can be interconnected to a frame 112 with hydraulic cylinders 114, for example four such hydraulic cylinders 114. The hydraulic cylinders 114 can be computer controlled via the computer/controller 80 to ensure the correct elevation of the replacement wall 10 and fixture 40, and to ensure equalized, uniform loading of same. The leveling bed 110 can also be used during changing the cable hook up during installation of the wall section, as illustrated in FIGS. 4A-C.

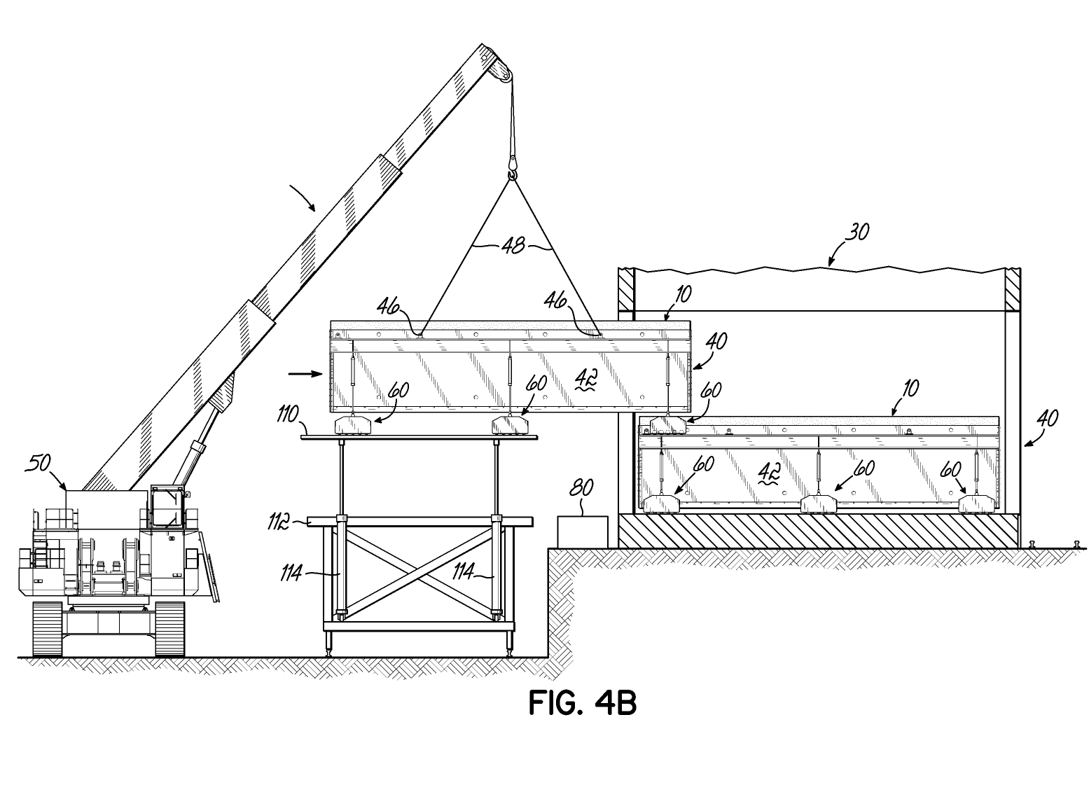

Lastly, FIG. 5 shows installation of replacement wall sections 10 by being lowered through the top 120 of the oven 30, which can be accomplished if the roof brick work is removed.

The embodiments shown and described are merely for illustrative purposes only. The drawings and the description are not intended to limit in any way the scope of the claims. Those skilled in the art will appreciate various changes, modifications, and alternative embodiments. All such changes, modifications and embodiments are deemed to be embraced by the claims. Accordingly, the scope of the right to exclude shall be limited only by the following claims and their equivalents.

What is claimed is:

1. (canceled)

2. A method of replacing a damaged wall of a coke oven, the damaged coke oven wall having an entire height h and an entire length l, the method comprising:
removing the damaged wall from the coke oven,
casting, outside of the coke oven, a plurality of unitary, one-piece replacement wall sections, each replacement wall section having a length equal to the entire length l of the damaged coke oven wall and a height equal to a fraction of the entire height h of the damaged coke oven wall, and
positioning, inside the coke oven, the plurality of replacement wall sections one on top of another, such that the plurality of replacement wall sections has a combined height equal to the entire height h of the damaged coke oven wall.

3. The method of claim 2 wherein the plurality of replacement wall sections comprises a lower half section and an upper half section.

4-6. (canceled)

7. The method of claim 2 wherein the replacement wall sections are cast with air/gas passages and vertical flues therein.

8-13. (canceled)

14. The method of claim 2 wherein the replacement wall sections are installed in the oven through an open end of the oven.

15. (canceled)

16. The method of claim 2 further comprising:
casting mortar joints in at least one of upper and lower surfaces of the replacement wall sections.

17-26. (canceled)
